(19) United States
(12) Patent Application Publication
(10) Pub. No.: US 2008/0209959 A1
(43) Pub. Date: Sep. 4, 2008

(54) Key Actuation Mechanism

(76) Inventor: Natalee Russo-Amati, Monongahela, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/041,155

(22) Filed: Mar. 3, 2008

Related U.S. Application Data
(60) Provisional application No. 60/904,526, filed on Mar. 2, 2007.

(51) Int. Cl. E05B 65/00

(52) U.S. Cl. 70/57

(57) ABSTRACT

A key actuation mechanism for mechanically moving a key having a grip end and an insertion end, the mechanism comprising: a housing; a key engagement member configured to releasably engage the grip end of the key, the engagement member moveable with respect to at least a portion of the housing; a drive mechanism in electrical communication with the key engagement member and configured to drive movement of the engagement member; and a switch in communication with the drive mechanism, the switch operable to activate the drive mechanism, which causes the engagement member to move.

### CROSS REFERENCE TO RELATED APPLICATIONS

This application claims the benefit of priority of U.S. Provisional Patent Application No. 60/904,526, filed Mar. 2, 2007, which is incorporated herein by reference in its entirety.

### BACKGROUND OF THE INVENTION

1. Field of the Invention

The present invention relates generally to devices for use in assisting persons with limited movement or other constraints and, in particular, to a key actuation mechanism and device for assisting a user with automated movement of a key within a lock mechanism.

2. Description of the Related Art

Presently, and in order to access secure areas, locks are normally used. For example, in order to access one's dwelling or home, the doors normally have a lock mechanism that bolts or otherwise renders the door immovable, except through the use of a key. Therefore, in order to gain access to the area behind the door, a person will insert the key into a keyhole extending into the lock mechanism. Next, the key is moved (normally “rotated”), and the bolt moved, such that the door can be opened and access gained. This same process is commonly used with a variety of locked objects, such as a car door lock, an ignition switch, powered equipment, etc.

In many instances, a user may approach the door, but not have the appropriate visibility to insert the key in the keyhole. Therefore, devices and mechanisms have been developed that provide a keychain (or other structure attached to the key) that has an activatable bulb, e.g., a flashlight or similar lighting device. Such devices and mechanisms can be found, for example, in U.S. Pat. Nos. 4,392,186; 5,730,013; 6,132,058; and 6,164,102.

Keys are fairly small in size, and the head or graspable or grip portion of the key is likewise small. Certain persons may have trouble grasping and rotating the key due to a variety of constraints, e.g., physical limitations, clothing (gloves), etc. Accordingly, prior art devices and arrangements have been developed for assisting the user in grasping and manually manipulating the key. Such devices and arrangements are disclosed, for example, in U.S. Pat. Nos. 4,583,383; 5,440,910; 5,730,013; 5,737,951; 6,164,102; and D406,046.

However, there remains considerable room in the art for further improvements of such devices, mechanisms and arrangements. For example, one drawback associated with the above-mentioned devices, mechanisms and arrangements is the manual nature of the key-turning or actuation operation. Many people have certain limitations, e.g., age, physical, etc., which makes the turning motion required to rotate the key after insertion in the keyhole difficult and/or painful. For example, people with physical disabilities, such as the elderly, the handicapped or those recovering from injuries or surgery encounter difficulties while performing tasks that most of us take for granted, i.e., turning a key in a lock. Often, the dexterity and wrist movements required are more than many can master. Additionally, those suffering from carpal tunnel syndrome find such movements extremely difficult as well. None of the prior art devices, mechanisms and arrangements alleviates the manual hand motion, movement or rotation required to unlock the lock mechanism with such a key.

### SUMMARY OF THE INVENTION

Accordingly, it is one object of the present invention to provide a key actuation mechanism that overcomes the drawbacks and deficiencies of the prior art. It is another object of the present invention to provide a key actuation mechanism that allows for the mechanical or automated movement or rotation of a key within a keyhole for unlocking a lock mechanism. It is a further object of the present invention to provide a key actuation mechanism that provides light to a typically darkened area. It is yet another object of the present invention to provide a key actuation mechanism that alleviates the pain and discomfort associated with moving the key within the keyhole. It is a still further object of the present invention to provide a key actuation mechanism that is easily grasped and provides for the simple positioning of the key in the keyhole.

The present invention is directed to a key rotation mechanism for mechanically rotating a key having a grip end and an insertion end. The mechanism includes a housing defining an inner area; and a key engagement member for releasably engaging the grip end of the key. The engagement member is moveably and/or rotatable with respect to at least a portion of the housing. The mechanism further includes a drive mechanism in electrical communication with the key engagement member for driving the movement of the engagement member. A switch is in communication with the drive mechanism, and the switch is operable to activate the drive mechanism, which causes the engagement member to move.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic view of one embodiment of a key rotation mechanism according to the principles of the present invention;

FIG. 2 is a perspective view of another embodiment of a key rotation mechanism according to the principles of the present invention;

FIG. 3 is a side, cross sectional view of a further embodiment of a key rotation mechanism according to the principles of the present invention; and

FIG. 4 is a side view of another embodiment of a key rotation mechanism according to the principles of the present invention.

### DETAILED DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

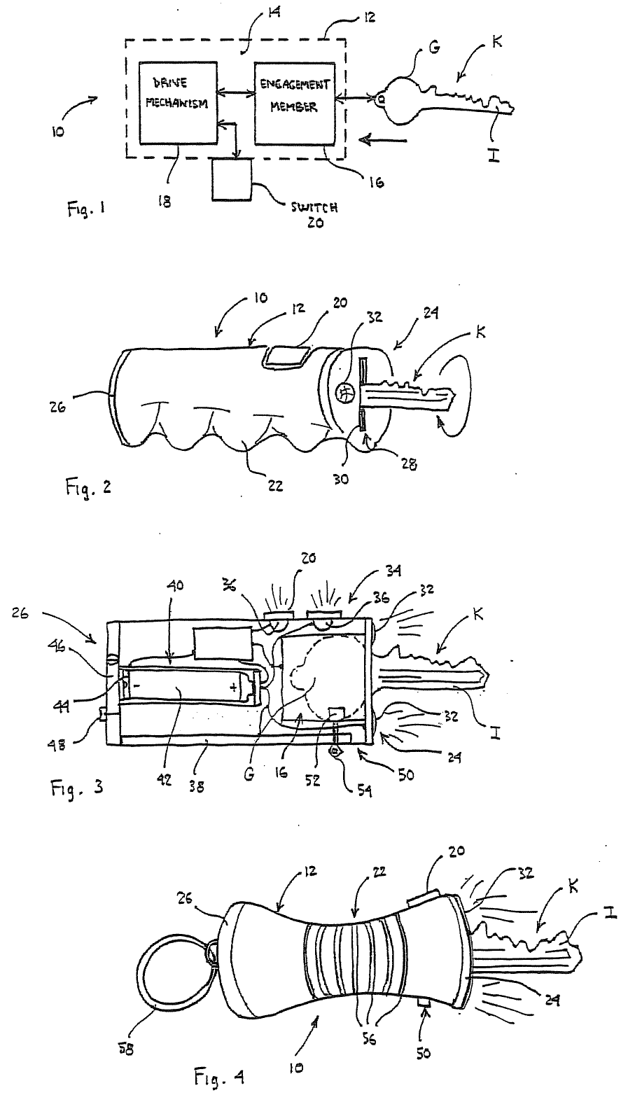

The present invention is directed to a key actuation mechanism 10, as illustrated in various embodiments and in use in FIGS. 1-4. The key actuation mechanism 10 is useful in connection with a variety of lock mechanisms (not shown), such as door locks, car door locks, ignition switches, powered equipment, etc. Further, the key actuation mechanism 10 serves to mechanically move a key K once it has been inserted into the key hole of the lock mechanism. Any type, degree or manner of movement of the key K is envisioned. For example, in one preferred and non-limiting embodiment, the key K is rotated by the key actuation mechanism 10 in a well-known rotating or “turning” movement.

As seen in FIG. 1, and in one preferred and non-limiting embodiment, the key actuation mechanism 10 is used for mechanically moving the key K, which includes a grip end G and an insertion end I. Specifically, and as is well known in the art, a user grasps the grip end G of the key K, and inserts the insertion end I into the keyhole (not shown) of the lock mechanism. Accordingly, the key actuation mechanism 10 is placed in operable communication with the grip end G of the key K.

In this embodiment, the key actuation mechanism 10 includes a housing 12, which, in one preferred and non-limiting embodiment, defines an inner area 14. Further, the mechanism 10 includes a key engagement member 16 associated with the housing 12, and which is configured or arranged to contact, grip or otherwise releasably engage the grip end G of the key K of the housing 12. This engagement member 16 is moveable or rotatable with respect to at least a portion of the housing 12. While discussed in some embodiments as being positioned in the inner area 14 of the mechanism 10, the key engagement member 16 may take a variety of different forms. For example, this key engagement member 16 may be a moveable portion or section of the housing 12 (as discussed hereinafter), or alternatively, in direct or indirect operational communication with the housing 12. In general, and in operation, the user grasps the housing 12, and the key engagement member 16 (which engages the key K) is moveable with respect to the grasped portion of the housing 12. Accordingly, a variety of structural and mechanical arrangements could be used and should be construed as being within the spirit and scope of the present invention.

The mechanism 10 further includes a drive mechanism 18 in electrical communication with the key engagement member 16. This drive mechanism 18 is used to drive or otherwise initiate the movement of the engagement member 16. A switch 20 is in communication with the drive mechanism 18, and this switch 20 is operable to activate the drive mechanism 18, which causes the engagement member 16 to move. Since the key K is attached to or otherwise engaged with the engagement member 16, the movement of the engagement member 16 imparts the substantially identical movement to the key K.

In use, the user inserts the insertion end I of the engaged key K into the keyhole. Next, the user actuates the switch 20, which causes the drive mechanism 18 to power and move the engagement member 16. In this manner, the key K is mechanically moved, turned or rotated within the keyhole to unlock the locked mechanism.

As seen in FIG. 2, the housing 12 may take many different forms. For example, the housing 12 in the preferred and non-limiting embodiment of FIG. 2, includes a grip portion 22 disposed on an outer surface of the housing 12, which allows the user to effectively and comfortably grasp and hold the housing 12 of the mechanism 10. This grip portion 22 may include areas or contours that adapt to or are adaptable to the particular user's grip or hand, which serves to maximize comfort during operation. In this embodiment, the switch 20 is located on the outer surface of the housing 12 and, in one preferred and non-limiting embodiment, is located in a position where the user's thumb may contact and actuate the switch 20.

As illustrated in FIG. 2, the housing 12 may include a first end 24 and a second end 26. The first end 24 of the housing 12 includes a key insertion orifice 28 extending through the housing 12 and permitting access to the inner area 14 of the housing 12, where the key engagement member 16 is situated. Accordingly, the user would insert the grip end G of the key K through the key insertion orifice 28 and into the inner area 14, such that the engagement member 16 could contact or otherwise engage the key K. The key insertion orifice 28 may include a variety of different sizes and shapes so as to accommodate the maximum number of keys K. Still further, the key insertion orifice 28 may include at least one guard member 30, which is attached to or around the key insertion orifice 28. This guard member 30 allows the grip end G of the key K to be inserted therethrough, but protects the inner area 14 of the housing 12 from dirt, grime, moisture, etc. For example, the guard member 30 may be in the form of pliable or flexible strips of material that allow passage of the key K, and substantially conform to a surface of the key K once inserted and engaged.

It is also envisioned that the mechanism 10 includes at least one light member 32. This light member 32 is positioned on an outer surface of the housing 12, and may be actuated when the switch 20 is actuated or activated, or alternatively, may have a separate actuation mechanism (as discussed hereinafter). In any case, the light member 32 may be positioned on the first end 24 of the housing 12, and projects light towards the insertion end I of the key K, which therefore projects light onto the keyhole and lock mechanism, ignition switch, power switch, etc.

FIG. 3 illustrates a further preferred and non-limiting embodiment of the key rotation mechanism 10 of the present invention. In this embodiment, a light switch 34 is provided. This light switch 34 serves to activate the light member 32, which, in this case, includes multiple light members 32 positioned on the first end 24 of the housing 12. Still further, in this embodiment, each of the switches 20, 34 are likewise lit or illuminated via switch lights 36. The switch lights 36 are positioned under or adjacent the switch 20 and light switch 34, and allow the user to easily locate and activate the switches 20, 34.

It is further envisioned that the switch lights 36 are continuously activated in a low-power state, or alternatively, are activated when the housing 12 is moved, manipulated or some other portion of the housing 12 contacted. For example, as illustrated in the embodiment of FIG. 3, a pressure contact member 38 is positioned on or adjacent the housing 12. When the user grasps, contacts and/or squeezes the housing 12, the pressure contact member 38 activates the switch lights 36. In this manner, the user will be able to easily recognize and use the switch 20 and/or the light switch 34.

In order to provide power to the drive mechanism 18, a power source 40 is provided. In particular, and in the embodiment of FIG. 3, a battery 42 serves as the power source 40 for providing electrical power to the drive mechanism 18 for powering the movement of the engagement member 16. Therefore, in one embodiment, within the inner area 14 of the housing 12, a battery compartment 44 is positioned and includes appropriate contacts for contacting, mating and/or transferring power from the battery 42 to the various components of the mechanism 10 that require electrical power for operation.

In order to insert the power source 40 (or battery 42) into the battery compartment 44, the second end 26 of the housing includes an access door 46. This access door 46 is configured to be opened to provide the user access to the battery compartment 44. In addition, the access door 46 may include an actuatable clip member 48 or other similar structure to allow the access door 46 to be removably held in place at the second end 26 of the housing 12. For example, the clip member 48 may be a locking arrangement, a clamp-type arrangement, a friction-contact arrangement, etc.

In some embodiments of the present invention, the key K is simply inserted into the housing 12, e.g., through the key insertion orifice 28, and into the inner area 14 of the housing 12. In certain embodiments, the engagement member 16 is sized and shaped so as to maintain the key K in appropriate contact with engagement member 16 through friction or other similar gripping arrangements. However, as shown in the embodiment of FIG. 3, an actuatable key release clip member 50 may be used or incorporated with the engagement member 16. This key release clip member 50 would include a key contact portion 52 and a user actuation portion 54.

This key release clip member 50 may be a spring-actuated member, a friction-gripping member, a clamp-type member, etc. In operation, the grip end G of the key K is inserted through the key insertion orifice 28 and contacts or otherwise becomes engaged with the key release grip member 50. In order to remove the key K from the engagement member 16, the user would actuate or pull the user actuation portion 54, which would remove the key contact portion 52 from engaging or contacting the grip end G of the key K. The user would then remove the key K and insert another key K therein. In this manner, the mechanism 10 may be used in connection with multiple different keys, and these keys K would be easily inserted within and removed from the housing 12. Of course, it is further envisioned that the engagement member 16 and/or the key contact portion 52 is external to housing 12 or positioned on a portion of the outer surface of the housing 12. A variety of manners and arrangements of removably engaging the key K with or within the mechanism 10 is envisioned.

As illustrated in FIG. 4, and in another preferred and non-limiting embodiment, the housing 12 may include a variety of forms and shapes. For example, as seen in this embodiment, the grip portion 22 is a series of ridges 56 that allow the user to effectively grasp and manipulate the housing 12. In addition, and as illustrated in this embodiment, a key ring 58 may be attached to the housing 12, which would allow the user to attach multiple keys K to the key ring 58. Therefore, the user would not be limited to only using a single type or style of key K in connection with the mechanism 10, instead allowing all the keys K to be stored near and used with the mechanism 10.

In one preferred and non-limiting embodiment, the engagement member 16 may be formed by or integral with the first end 24 of the housing 12, where this first end 24 is rotatable with respect to the housing 12. The key K is inserted in the key insertion orifice 28 into the inner area 14 of the housing 12, with the insertion end I of the key K projecting from the key insertion orifice 28. In operation, the first end 24 of the housing 12 rotates, such that the sides of the key K bear against the sides of the key insertion orifice 28, thereby causing the key K to rotate as well. In addition, and in this embodiment, the light member 32 is positioned on the housing 12 in the form of a ring that extends around the periphery of the first end 24 of the housing 12. Such an arrangement will cause light to emanate from the light member 32 on all sides of the key K.

It is envisioned that the entire housing 12 can be lit or otherwise illuminated by grasping the housing 12, such as by contacting a pressure contact member 38. Therefore, the housing 12, as well as the first end 24 of the housing 12, the switch 20, the light switch 34, the key release clip member 50, etc. may be manufactured from a material that allows for light to emanate therethrough. Further, the housing 12 may be in an ergonomically preferable form that allows for the greatest comfort to the user when grasping and using the mechanism 10. Any number of such arrangements, shapes, sizes and forms are envisioned within the scope of the present invention. The shape of the housing 12, as discussed above, can take any form for geometry that is easy for the user to grasp and hold. Further, when attached to a key ring 58, the key actuation mechanism 10 allows the user to place additional keys or other devices through the mechanism 10.

In this manner, the present invention provides a key actuation mechanism 10 that moves, turns or rotates the key K in the keyhole of the lock mechanism without requiring any wrist movement of the user. Therefore, the present invention can be used by the elderly and/or disabled suffering from reduced physical dexterity. In addition, the key actuation mechanism 10 is ideal for those suffering from carpal tunnel syndrome, arthritis, amputation and the like. Due to the mechanical nature of the mechanism 10, the user is provided with increased independence and reduced reliance upon others to engage in such activities. In addition, the key actuation mechanism 10 can be used on door locks, car locks, ignition switches, or virtually any lock or switch that requires a twisting (or other) motion for actuation.

The drive mechanism 18, which is powered by the power source 40, may take many different forms. For example, the drive mechanism 18 may be a gear reduction mechanism or the like. The drive mechanism 18 is actuated or otherwise controlled by the switch 20, which is positioned on the housing 12 of the mechanism 10. When the power source 40 is a battery 42, this allows the user to effectively utilize the mechanism 10 in many different places, and such a battery 42 is replaceable.

By including at least one light member 32, the user may illuminate the lock mechanism or lock area for use in appropriately inserting the insertion end I of the key K into the keyhole. In addition, the light member 32 is ideal for use at night or at other locations that are poorly lit. Further, and as discussed, the housing 12 may be manufactured from a variety of materials. For example, the housing 12 may be manufactured from a synthetic material that is strong and durable, easy to manufacture and cost-effective. Further, the housing 12 may include some easily-grippable material, such as rubber or the like, and may also have some friction layer or other material that prevents the user from accidentally dropping the mechanism 10.

As discussed, the mechanism 10 can impart any manner of movement upon the key K in order to lock or unlock the locking mechanism of the object, e.g., door, etc. Further, the mechanism 10 may include appropriate components to stop the movement or rotation of the key K after moving it a specified amount, such as in the form of a stop or other component that senses that the key K has been fully moved within the keyhole to actuate the locking mechanism. In addition, it is envisioned that the mechanism 10 can include the appropriate sensors, components or circuitry that permit the key K to be moved through any manner of locking or unlocking motions. For example, the switch 20 (whether pressed, slid or otherwise moved) may have certain movements, e.g., clockwise rotation, counterclockwise rotation, upward movement, downward movement, etc., defined and implemented based upon the position of the switch 20. For example, the switch 20 may be moved to one position to move the key K in a clockwise rotation, and another position to move the key K in a counterclockwise rotation, wherein this rotational movement (whether clockwise or counterclockwise) is stopped when the mechanism 10 senses that the key K has reached an end point in the turning movement. Any such variation in movement of the key K to lock or unlock a locking mechanism is envisioned.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A key actuation mechanism for mechanically moving a key having a grip end and an insertion end, the mechanism comprising:
a housing;
a key engagement member configured to releasably engage the grip end of the key, the engagement member moveable with respect to at least a portion of the housing;
a drive mechanism in electrical communication with the key engagement member and configured to drive movement of the engagement member; and
a switch in communication with the drive mechanism, the switch operable to activate the drive mechanism, which causes the engagement member to move.

2. The key actuation mechanism of claim 1, wherein the movement of the engagement member is an at least partial rotation, thereby at least partially rotating the insertion end of the engaged key.

3. The key actuation mechanism of claim 1, wherein the housing comprises an outer surface having a grip portion positioned on at least a portion of the outer surface and configured to permit a user to grasp the housing.

4. The key actuation mechanism of claim 1, wherein the housing comprises an outer surface, and wherein the switch is positioned on and extends from an area of the outer surface such that the switch is actuatable by a user's thumb.

5. The key actuation mechanism of claim 1, further comprising a key insertion orifice extending through a first end of the housing, the key insertion orifice configured to allow for passage of at least a portion of the grip end of the key into an inner area of the housing and in contact with the key engagement member.

6. The key actuation mechanism of claim 5, further comprising a guard member associated with the key insertion orifice and configured to prevent or minimize entry of foreign materials through the key insertion orifice to inner area of the housing.

7. The key actuation mechanism of claim 1, further comprising at least one light member positioned on an outer surface of the housing and configured to illuminate an area adjacent the light member.

8. The key actuation mechanism of claim 7, wherein the at least one light member is activated by at least one of the following: actuation of the switch, actuation of a light switch or any combination thereof.

9. The key actuation mechanism of claim 8, wherein at least one of the switch and the light switch are illuminated by at least one switch light positioned adjacent thereto.

10. The key actuation mechanism of claim 9, wherein the at least one switch light is at least one of: continuously activated, activated when the housing is moved, activated when the housing is manipulated, activated when the housing is contacted or any combination thereof.

11. The key actuation mechanism of claim 10, further comprising a contact member associated with the housing and configured to activate the at least one switch light when the contact member is contacted by a user.

12. The key actuation mechanism of claim 1, further comprising a power source configured to provide power to at least one of the following: the drive mechanism, at least one light member, at least one switch light, a contact member or any combination thereof.

13. The key actuation mechanism of claim 12, wherein the power source is at least one battery.

14. The key actuation mechanism of claim 12, wherein the power source is in the form of a removable member configured to be inserted and removed into and from an inner area of the housing via an access door positioned on a second end of the housing.

15. The key actuation mechanism of claim 1, further comprising a key release grip member configured to directly or indirectly contact and engage at least a portion of the grip end of the key after engagement with the key engagement member.

16. The key actuation mechanism of claim 15, wherein the key release grip member comprises:
a key contact portion configured to directly contact and engage at least a portion of the grip end of the key; and
a user actuation portion in operational communication with the key contact portion and configured to drive or release the engagement between the key contact portion and the grip end of the key.

17. The key actuation member of claim 15, wherein the key release grip member is at least one of the following: a spring-actuated member, a friction-gripping member, a clamp-type member or any combination thereof.

18. The key actuation member of claim 1, further comprising a key ring attached to a portion of the housing and configured to removably retain at least one key thereon.

19. The key actuation member of claim 1, wherein the housing has a first end and a second end, wherein the first end at least partially comprises the key engagement member and is movable with respect to the second end of the housing.

20. The key actuation member of claim 1, wherein at least a portion of the key actuation member is formed from an at least partially transparent material configured to permit light to pass therethrough.
